(19) United States
(12) Patent Application Publication
(10) Pub. No.: US 2010/0058906 A1
(43) Pub. Date: Mar. 11, 2010

(54) METHOD FOR CUTTING FERROUS MATERIAL AND CUTTING FLUID SUPPLY DEVICE

(75) Inventors: Akihiro Inada, Wako-shi (JP); Hitoshi Ohmori, Wako-shi (JP)

Correspondence Address: GRIFFIN & SZIPL, PC, SUITE PH-1, 2300 NINTH STREET, SOUTH, ARLINGTON, VA, 22204, US

(73) Assignee: RIKEN, Saitama (JP)

(21) Appl. No.: 12/431,135

(22) Filed: Apr. 28, 2009

(30) Foreign Application Priority Data
Sep. 10, 2008 (JP) 2008-232178

(51) Int. Cl. B26D 7/08

(52) U.S. Cl. 83/22; 83/169

(57) ABSTRACT

In a method for cutting ferrous material in accordance with the present invention, a water-soluble cutting fluid containing nanometer-size carbon particles is electrolyzed, and a ferrous workpiece is cut by a diamond cutting tool 9 while supplying the electrolyzed water-soluble cutting fluid onto a cutting point between the diamond cutting tool 9 and the ferrous workpiece.

### BACKGROUND OF THE INVENTION

1. Field of the Invention

The present invention relates to a method for cutting ferrous material by a diamond cutting tool and a cutting fluid supply device for supplying a cutting fluid to a cutting point between the diamond cutting tool and the ferrous workpiece.

2. Description of the Related Art

Intensive efforts have been focused on the research and development related to micromachining of molds for a variety of test boards in the fields of optical devices and leading-edge medicine. Diamond cutting tools are not commonly used in micromachining for the following reason. When a ferrous material, such as a steel material or the like, is cut using a diamond cutting tool for micromachining, the diamond cutting tool and the ferrous material are brought into constant contact with each other. This causes the diamond cutting tool to wear very easily, because the carbon of the diamond cutting tool has high chemical affinity with ferrous material, thus making it impossible to successfully achieve micromachining with high accuracy in shaping or obtaining mirror-finished surfaces.

However, further sophisticated machining technologies have been called for with the recent development of industrial technologies, and there has been high demand for implementing successful cutting of ferrous material by diamond cutting tools. In response to the demand, there has been proposed a new cutting technique called the elliptical vibration cutting method (refer to, for example, Patent Document 1 mentioned below).

According to the elliptical vibration cutting method, as illustrated in FIG. 1, a vibration in a cutting direction and a vibration in a chip discharge direction are applied at the same time to a cutting blade 1A of a cutting tool 1 by using a piezoelectric device or the like, and the cutting blade 1A is moved along an elliptical vibration trajectory 2. Then, in this state, the cutting blade 1A is pressed against a workpiece 3 to cut the workpiece 3. The elliptical vibration of the cutting blade 1A causes a chip 4 to be pulled up while cutting, so that a required cutting force is reduced and highly accurate machining can be achieved.

According to the elliptical vibration cutting method described above, a vibration in a horizontal direction (cutting direction) and also a vibration in a vertical direction (a chip discharge direction) are applied to a blade edge to cut a workpiece, thus making it possible to achieve reduced time of continuous contact between a diamond tool and a workpiece, a reduced force of friction with chips, reduced cutting resistance, and improved permeation of a cutting oil solution. This permits restrained wear on the diamond tool.

[Patent Document 1]

Japanese Patent Application Laid-Open No. 2000-52101

However, the aforesaid elliptical vibration cutting method requires a vibration generating mechanism, such as a piezoelectric device, resulting in the need for a complicated, costly actuator. Further, it is difficult to optimize or control a vibration frequency for obtaining a desired machining accuracy. Accordingly, there has been a demand for a technique which allows ferrous material to be easily cut by using a diamond cutting tool without the need for a complicated actuator or control.

### SUMMARY OF THE INVENTION

The present invention has been made with a view toward solving the above problem, and it is an object of the invention to provide a method for cutting ferrous material and a cutting fluid supply device which allow ferrous material to be cut by using a diamond cutting tool without the need for a complicated actuator or control.

To this end, a method for cutting ferrous material and a cutting fluid supply device in accordance with the present invention adopt the following technological means.

(1) The method for cutting ferrous material in accordance with the present invention has the steps of:

electrolyzing a water-soluble cutting fluid containing nanometer-size carbon particles; and

cutting a ferrous workpiece by a diamond cutting tool while supplying the electrolyzed water-soluble cutting fluid onto a cutting point between the diamond cutting tool and the ferrous workpiece.

(2) Further, in the method for cutting ferrous material described in (1) above, the electrolyzed water-soluble cutting fluid contains s substance which has a corrosion action on ferrous material.

(3) Further, in the method for cutting ferrous workpiece described in (2) above, the substance which has a corrosion action on ferrous material is chlorine ion.

(4) A cutting fluid supply device in accordance with the present invention supplies a water-soluble cutting fluid containing nanometer-size carbon particles to a cutting point between a diamond cutting tool and a ferrous workpiece, and includes an electrolytic device for electrolyzing the water-soluble cutting fluid.

(5) Further, in the cutting fluid supply device described in (4) above, the electrolyzed water-soluble cutting fluid contains a substance which has a corrosion action on ferrous material.

(6) Further, in the cutting fluid supply device described in (5) above, the substance which has the corrosion action on the ferrous material is a chlorine ion.

According to the present invention, the nanometer-size carbon particles (nano carbon) contained in the water-soluble cutting fluid adhere to a cutting blade of the diamond cutting tool and form a coating layer. The coating layer made of the nano carbon functions as a solid lubricant, thus causing the surface of the cutting blade to have a reduced frictional coefficient. This provides a high lubrication effect, making it possible to prevent or restrain chips from adhering to the diamond cutting tool. Moreover, the coating layer functions as a protective layer, so that the wear on the diamond cutting tool can be prevented or reduced.

When the water-soluble cutting fluid is electrolyzed, substances, such as chlorine ion, which is contained in a cutting fluid and which has a corrosion action on ferrous material, modifies the surface of the ferrous workpiece and weakens the structure thereof. This permits improved cutting performance.

Electrolyzing the water-soluble cutting fluid provides another advantage. An electrostatic force causes chips, which are produced during a cutting process, to move to an edge or a peripheral portion of the cutting fluid accumulated on the workpiece, so that the chips are efficiently discharged from a cutting point and a machined surface. This arrangement makes it possible to effectively prevent a machining failure caused by clogging of chips from occurring.

Thus, according to the present invention, a ferrous material can be cut using a diamond cutting tool without the need for a complicated actuator or control.

### BRIEF DESCRIPTION OF THE DRAWINGS

FIG. 1 is a graphical illustration of an elliptical vibration cutting method according to a prior art;

FIG. 2 is a schematic diagram of a cutting fluid supply device according to an embodiment of the present invention;

FIG. 3 is a schematic diagram illustrating operations and advantages of the present invention;

FIG. 4A presents a photograph showing an enlarged view of a cut groove machined using kerosene mist, and a chart illustrating the geometry of a surface of the cut groove;

FIG. 4B presents a photograph showing an enlarged view of a cut groove machined using a nano-carbon electrolytic coolant, and a chart illustrating the geometry of the surface of the cut groove;

FIG. 5 presents two photographs, namely, an upper photograph in which the left half thereof illustrates a cut groove machined using the nano-carbon electrolytic coolant, while the right half thereof illustrates a cut groove machined using the kerosene mist, and a lower photograph illustrates an enlarged view of a surface machined using the kerosene mist;

FIG. 6A is a photograph showing an enlarged view of a wearing portion of a relief surface of a single-crystal diamond cutting tool observed after a machining experiment carried out using the kerosene mist illustrated in FIG. 5;

FIG. 6B is a photograph showing an enlarged view of a wearing portion of a relief surface of a single-crystal diamond cutting tool observed after a machining experiment carried out using the nano-carbon electrolytic coolant illustrated in FIG. 5;

FIG. 7 is a chart illustrating the measurement results of principal components of cutting forces associated with four different coolants;

FIG. 8 is a chart illustrating the results of tool life tests at different cutting speeds when the nano-carbon electrolytic coolant is used in a cutting process;

FIG. 9A is a photograph showing the form of a chip produced during a machining process using the nano-carbon electrolytic coolant;

FIG. 9B is a photograph showing the form of a chip produced during a machining process using the kerosene mist;

FIG. 9C is another photograph showing the form of a chip produced during a machining process using the nano-carbon electrolytic coolant;

FIG. 10 illustrates a thin film formed on a diamond cutting face after a 1-hour cutting operation performed with the nano-carbon electrolytic coolant;

FIG. 11 is a chart illustrating analysis results obtained by EPMA of the thin film on the diamond cutting face shown in FIG. 10;

FIG. 12 is a graph illustrating the measurement results of the microhardness of the machined surfaces of workpieces obtained using three different coolants;

FIG. 13 is a chart illustrating the indentation depth of an indenter of a microstrength meter and the thickness of a modified surface layer;

FIG. 14 illustrates a relationship between the magnitude of electrolytic energy for imparting an electrolytic action and principal components of cutting forces;

FIG. 15 is a photograph of the surface of a cut area when the nano-carbon electrolytic coolant is used;

FIG. 16 presents photographs showing a micro chip produced during a machining process using the nano-carbon electrolytic coolant;

FIG. 17 illustrates the form of a chip obtained under a condition using the coolant of a sodium sulfate solution;

FIG. 18 comparatively illustrates a coolant edge observed when cutting was performed using the nano-carbon electrolytic coolant and a coolant edge observed when cutting was performed using a nano-carbon coolant;

FIG. 19A illustrates a result of an experiment for verifying a chip discharge action imparted by an electrolytic action; and

FIG. 19B illustrates a result of an experiment for verifying a chip discharge action under no imparted electrolytic action.

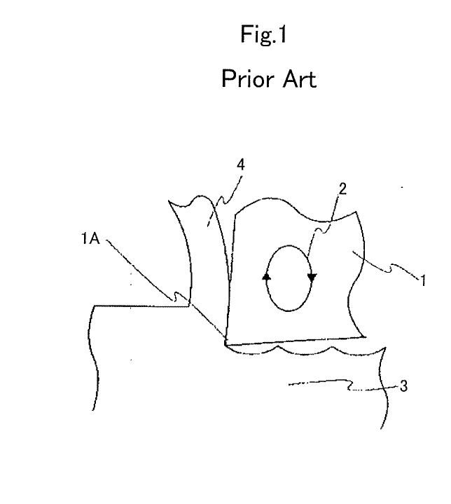

### DESCRIPTION OF THE PREFERRED EMBODIMENTS

Preferred embodiment of the present invention will be described in detail with reference to the accompanying drawings. Like reference numerals will be assigned to like components in the drawings, and duplicate description will be omitted.

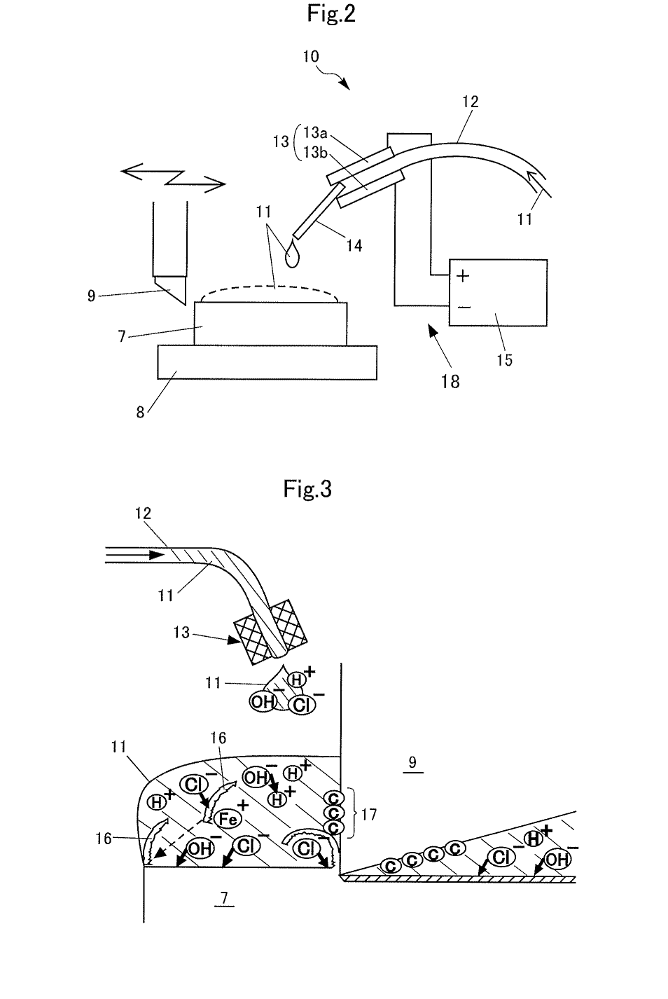

FIG. 2 schematically illustrates the construction of a cutting fluid supply device 10 according to an embodiment of the present invention. Referring to FIG. 2, a workpiece 7, which is a ferrous workpiece made of a steel material, is placed on a table, and a diamond cutting tool 9 is moved by a tool driving mechanism (not shown) in a tool feeding direction (in the lateral direction in the drawing) thereby to carry out cutting work on the workpiece 7. The cutting fluid supply device 10 is provided to supply a cutting fluid (coolant) 11 to a cutting point between the workpiece 7 and the cutting tool 9.

The cutting fluid supply device 10 has a coolant tube 12 constituting the passage of the cutting fluid 11, an electrolysis electrode 13 provided on the distal end of the coolant tube 12, an auxiliary supply tube 14 attached to the distal end of the electrolysis electrode 13, and an electrolysis power source 15 for applying an electrolysis voltage to the electrolysis electrode 13.

The cutting fluid 11 is a water-soluble cutting fluid which contains nanometer-size carbon particles and also contains substances which generate ions (e.g., chlorine ion, sulfate ion, nitrate ion, and carbonate ion) having a corrosion action on ferrous material when subjected to electrolysis. Substances that generate ions having the corrosion action on ferrous material when subjected to electrolysis include, for example, chlorine (Cl) and sodium sulfate (Na₂SO₄). The concentration of the nano carbon preferably ranges from 0.0001 wt % to 0.1 wt %.

An electrolytic device 18 which electrolyzes a water-soluble cutting fluid is constituted of the electrolysis electrode 13 and the electrolysis power source 15.

The electrolysis electrode 13 has a first electrode 13a and a second electrode 13b, which are disposed facing each other with the passage of the cutting fluid 11 sandwiched therebetween. There is no particular restriction on the material used for the electrolysis electrode 13 as long as the material is an electrically conductive material, such as metal. Preferably, however, the electrolysis electrode 13 is made of a material having high corrosion resistance and preferably made of, for example, a carbon electrode.

The electrolysis voltage generated by the electrolysis power source 15 is preferably a DC pulse voltage. Alternatively, however, the electrolysis voltage may be a DC fixed voltage or an AC voltage. When the electrolysis voltage is applied across the first electrode 13a and the second electrode 13b by the electrolysis power source 15, the cutting fluid 11 is electrolyzed while flowing between the first electrode 13a and the second electrode 13b. This causes the ingredients of the cutting fluid 11 to be electrolyzed, mainly producing hydrogen ion, hydroxide ion, and chlorine ion.

The auxiliary supply tube 14 is disposed such that the cutting fluid 11 is supplied onto a cutting point of the workpiece 7. With this arrangement, the cutting fluid 11 which has been electrolyzed is supplied onto the cutting point between the workpiece 7 and the diamond cutting tool 9, forming a liquid pool on the workpiece 7, as illustrated in FIG. 2.

The method for cutting ferrous material in accordance with the present invention can be implemented by using the cutting fluid supply device 10 constructed as described above. More specifically, in the method for cutting ferrous material in accordance with the present invention, the water-soluble cutting fluid 11 containing nanometer-size carbon particles is electrolyzed, and the ferrous workpiece 7 is cut by the diamond cutting tool 9 while supplying the electrolyzed water-soluble cutting fluid 11 onto a cutting point between the diamond cutting tool 9 and the ferrous workpiece 7.

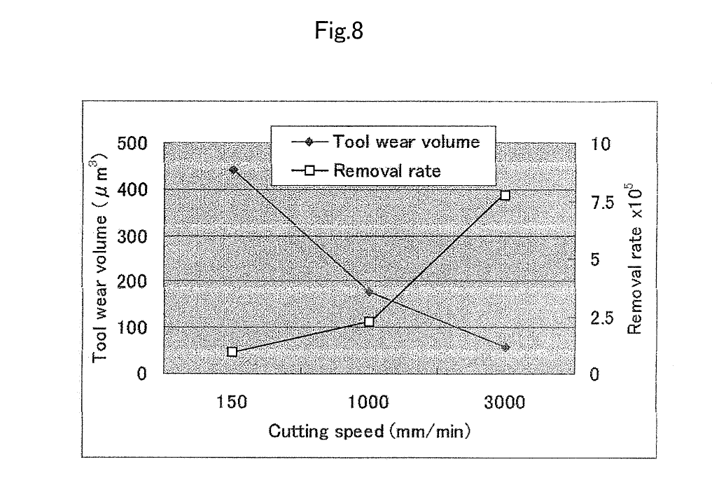

An experiment, which will be described later, has proved that a higher cutting speed reduces the wear on a cutting tool with a resultant prolonged service life, as illustrated in FIG. 8. The results of the experiment indicate that the cutting speed is preferably set to be faster than 150 mm/min, and preferably set to, for example, 200 mm/min or more, 1000 mm/min or more, or 3000 mm/min or more.

Referring to the schematic diagram of FIG. 3, the operations and advantages of the present invention will be described.

According to the device and the method in accordance with the present invention described above, the nanometer-size carbon particles contained in the water-soluble cutting fluid 11 adhere to a cutting blade surface of the diamond cutting tool 9 and form a carbon coating layer 17. The coating layer 17 composed of the nanometer-size carbon particles functions as a solid lubricant, thereby reducing the friction coefficient of the cutting blade surface. This provides high lubricant effect, making it possible to prevent or restrain chips 16 from adhering to the diamond cutting tool 9. Further, the coating layer 17 functions as a protective layer, so that the wear on the diamond cutting tool 9 can be prevented or reduced.

Further, electrolyzing the water-soluble cutting fluid 11 causes substances, such as chlorine ion, which are contained in the cutting fluid 11 and which have a corrosion action on the ferrous workpiece 7, to modify the surface of the ferrous workpiece 7 and weaken the crystal structure thereof, thus permitting improved cutting performance.

As another action obtained by electrolyzing the water-soluble cutting fluid 11, the chips 16 produced during a cutting process move to an edge or a peripheral portion of the cutting fluid 11 accumulated on the workpiece due to an electrostatic force, so that the chips 16 are efficiently discharged from a cutting point and a machined surface. This arrangement makes it possible to effectively prevent the occurrence of a machining failure caused by the clogging of the chips 16.

Thus, according to the present invention, a ferrous material can be cut using a diamond cutting tool without the need for a complicated actuator or control.

### EXAMPLES

To verify the advantages of the present invention, the following experiments have been conducted. The experiments, including the results thereof, will be described as examples of the present invention.

### 1. Experimental Conditions

For the samples, a high-carbon chromium steel material of Hv 800 or more which has high affinity with a single-crystal diamond cutting tool and which can be quenched was used to clarify the effects of coolants (cutting fluids). The following four types of coolants were used.

(1) Kerosene mist (for reference)

(2) Chemical solution type coolant (ELID grinding fluid was used for the experiments.)

(3) Nano-carbon coolant prepared by adding nanometer-size carbon particles to the coolant of (2)

(4) Nano-carbon electrolytic coolant prepared by electrolyzing the coolant of (3)

The concentrations of the nanometer-size carbon particles of the nano-carbon coolant and the nano-carbon electrolytic coolant used for the experiments were adjusted by diluting a nano-carbon aqueous solution, Aqua-Black 162 (nano-carbon concentration: 20 wt %; PH-7) by TOKAI CARBON, by a chemical solution type ELID grinding fluid (50-fold dilution factor). The average particle size of the carbon black of the Aqua-Black 162 is approximately 100 nm.

The experimental device which imparted an electrolytic action to the coolants has the same construction as that of the cutting fluid supply device (FIG. 2) in accordance with the present invention described above. In the device, the nano-carbon coolant flows between the electrodes to which an electrolysis power source is connected, and the coolant droplets to which the electrolytic action has been imparted are supplied to a machining point thereby to soak a cutting portion with the coolant.

The electrolytic conditions were a release voltage of 15V, a peak current of 1.7 A, pulse timings of 1-μs ON and 1-μs OFF, carbon electrode dimensions of 15×35×8 mm, and an electrode-to-electrode gap of 1.2 mm. The experimental device used was a nano-machine, Nano-100 by Sodick Co., Ltd. The Nano-100 is constructed of an air static-pressure bearing and a linear motor and has an X-axis, a Y-axis, and a Z-axis, and two rotating axes, namely, a B-axis and a C-axis. The experiment adopted planar cutting based on the experimental conditions indicated in Table 1 below as the reference conditions.

TABLE 1

| | |
|---|---|
| Sample | High-carbon chromium steel (Hv 800 or |
| | more) |
| Experimental Device | Nano-100 made by Sodick Co., Ltd. |
| Tool | Single-crystal diamond R cutting tool, |
| | R = 800 μm |
| Cutting Condition | Cutting speed: 150 mm/min |
| Coolant | Kerosene mist (Mist coolant); Supply |
| | amount: Minute amount |

The concentration of the nanometer-size carbon particles ranged from 0.0001 wt % to 0.001 wt % based on a prior verification result obtained by using oxygen-free copper for a workpiece. A multicomponent miniature dynamometer 9256C by Kistler was used to measure cutting forces.

### 2. Experiment Results

### 2.1 Comparative Results of Roughness of Machined Surfaces

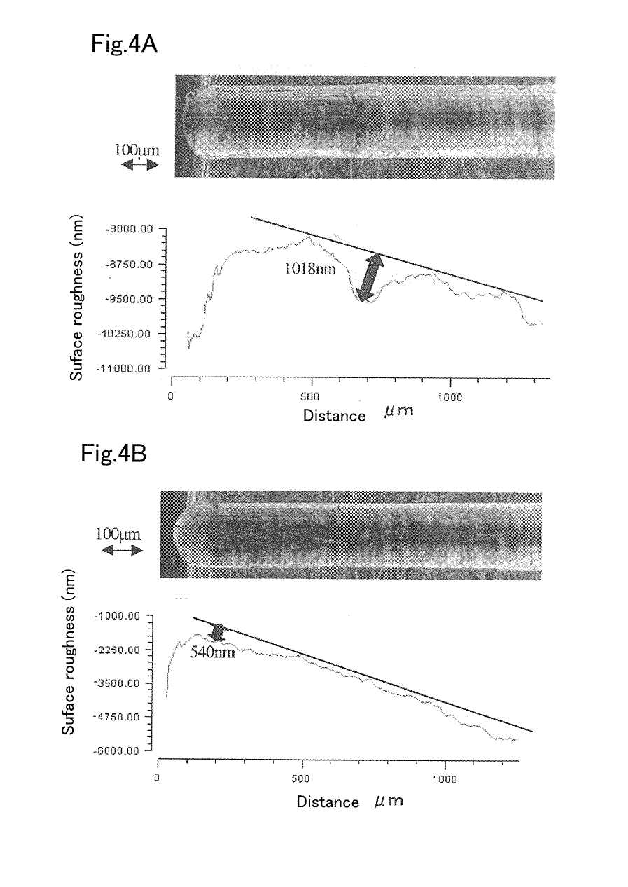

FIG. 4A presents a photograph of an enlarged view of a cut groove machined using kerosene mist as the coolant under the conditions given in Table 1, and a chart illustrating the surface geometry thereof. FIG. 4B presents a photograph of an enlarged view of a cut groove machined using a nano-carbon electrolytic coolant having a nanometer-size carbon particle concentration of 0.001%, and a chart illustrating the surface geometry thereof. The cut groove in FIG. 4A was evaluated using a digital microscope VHX-500 made by KEYENCE, while the cut groove in FIG. 4B was evaluated using New View 5000 made by Zygo.

The comparison of the data on the surface geometries indicates that the machined surface in FIG. 4A has a local undulation including a recession of 1018 nm in terms of PV value. In contrast, the machined surface in FIG. 4B does not show a marked undulation with a recession observed with the surface machined with kerosene mist, although a recession of 540 nm is observed in a region at the beginning of the cut groove. These two grooves have cut groove widths of 192 μm and 149 μm, respectively, at the cutting start portions. Because of the different groove widths, the cutting depths at the cutting start portions are 5.66 μm and 3.52 μm, respectively, meaning that the former is cut deeper than the latter by 2.14 μm. The latter, however, shows no notable recessed geometric irregularities even in a machined region where the width of the cut groove is 192 μm. This establishes that the cutting performance has been improved by using the nano-carbon electrolytic coolant.

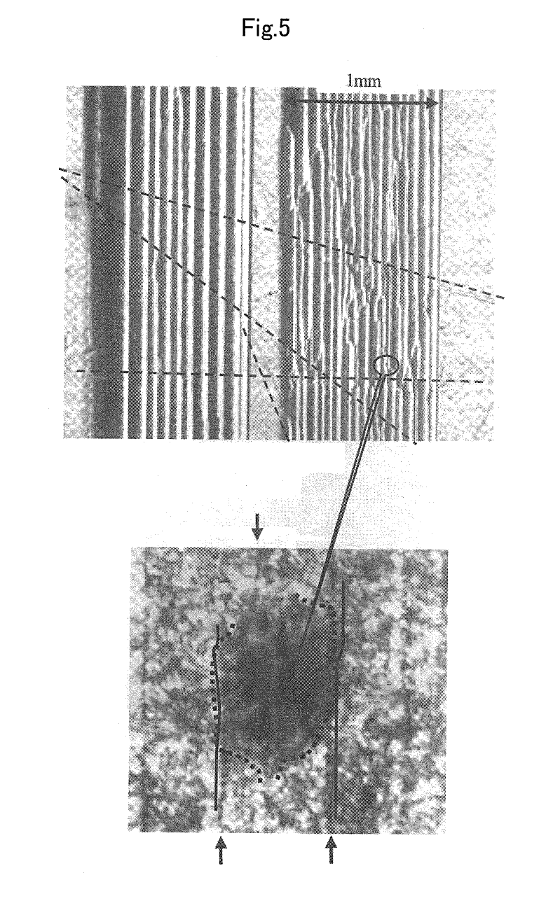

FIG. 5 presents photographs of enlarged views of a portion machined for a width of 1 mm under the same conditions as those given in Table 1, the pick feed being set at 5 μm. The lower photograph is a fragmentary enlarged view of the upper photograph. Referring to the upper photograph in FIG. 5, the right half illustrates a surface machined using the kerosene mist, while the left half illustrates a surface machined using the nano-carbon electrolytic coolant. The surface machined using the kerosene mist at right shows intermittent irregularities in the cut grooves, each having a width of approximately 50 μm, while the surface machined using the nano-carbon electrolytic coolant at left shows little irregularities in the cut grooves. The cutting depth of the former is 2.2 μm at the cutting start and 4.0 μm at a cutting end. Similarly, the cutting depth of the latter is 2.8 μm at the cutting start and 5.0 μm at the cutting end. The grooves of the former are slightly shallower by 0.6 μm to 1.0 μm. The comparison of the regions of the similar depths indicates an obvious difference in the surface state between the two machined surfaces.

Further, from the detailed observations of the photos in FIG. 5, the irregularities of the cut grooves seem to meet the extended lines of large scratches among grinding streaks, which were on the surface of the sample from the beginning (indicated by the dashed lines in the upper photograph in FIG. 5), or the positions of crystal grain boundaries (FIG. 5).

The lower photograph in FIG. 5 is the enlarged view of the surface machined using the kerosene mist by slightly over-etching with an etchant composed of 85-ml methanol, 5-ml nitric acid, and 10-ml hydrochloric acid. A crystal grain boundary indicated by the wavy lines is observed at the central portion of the enlarged view. It can be seen that a vertical cutting streak at left of the crystal grain boundary is discontinuous. In the photograph, the solid line is drawn at a position which is slightly away from the position of the cutting streak, the arrows indicating the position of the cutting streak. The observation results described above prove that the machining with the nano-carbon electrolytic coolant reduces machining defects, such as scratches left on the frontmost surface of a workpiece, and the influences of the anisotropy of crystal structures caused by different azimuths of individual crystal grains.

### 2.2 State of a Tool

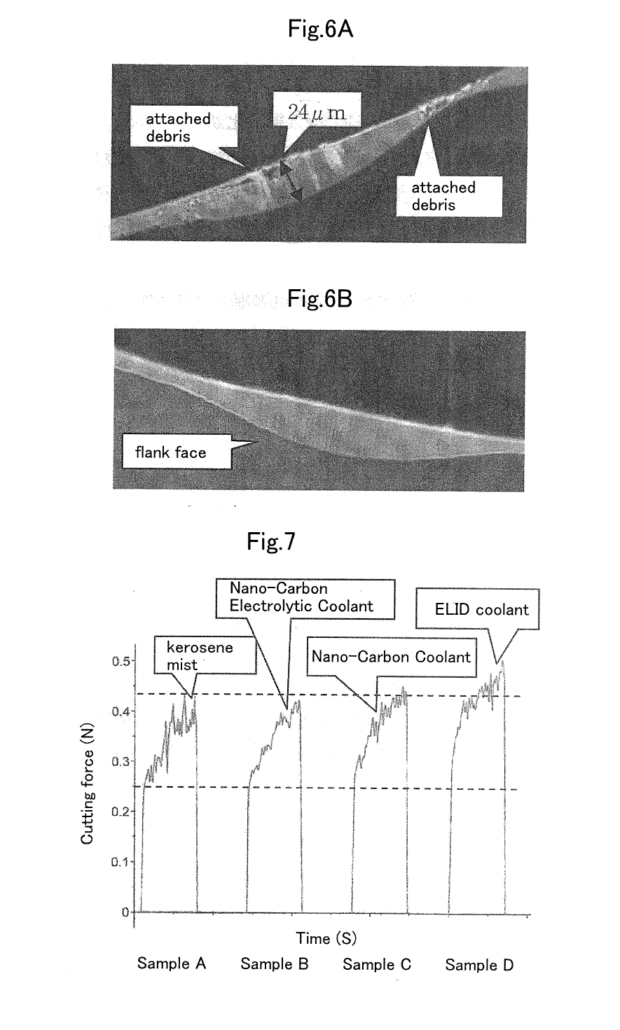

FIGS. 6A and 6B are photographs of enlarged views of wearing portions of the flank faces of single-crystal diamond cutting tools observed after the machining experiments (FIG. 5) conducted using the kerosene mist and the nano-carbon electrolytic coolant, respectively. The presence of attached debris was recognized on the wearing portion of the flank face of the former, while the wearing portion of the flank face of the latter was extremely clean and the presence of attached debris was not recognized. During the machining process, a situation wherein chips adhere to the cutting face of the tool and do not come off was frequently observed in the former, while chips were found to easily come off the blade edge during the machining process in the latter. These observation results prove that the added nanometer-size carbon particles make it possible to restrain ferrous chips from attaching to a single-crystal diamond cutting tool.

FIG. 7 illustrates the measurement results of principal components of cutting forces associated with the four different coolants. The cutting depth is approximately 600 nm based on an actually measured cut groove width and the cutting area is approximately 1.6×10⁸ nm². Experimental cutting by using the kerosene mist (Sample A at the leftmost end) was carried out first, and then the experimental cutting by using the chemical solution type ELID grinding fluid (Sample D), the experimental cutting by using the nano-carbon coolant (Sample C), and the experimental cutting by using the nano-carbon electrolytic coolant (Sample B) were carried out in this order. No marked difference is observed in the values of the principal components of cutting forces among Samples A, B and C, whereas the principal component of the cutting force of Sample D shows an increase of approximately 13%. The difference is presumably caused mainly by the poor lubricity of the ELID coolant and adhesion of chips, although not clear.

The comparative observation of the experiment results of Samples A, B and C has disclosed that the fluctuation ranges of the principal components of cutting forces in the cutting process differ, although all the three different coolants have nearly the same minimum value of 0.26N and maximum value of 0.43N. The changing degrees of the fluctuation ranges expressed in terms of a ratio relative to a mean value of the principal components of cutting forces are the nano-carbon electrolytic coolant of 11.9%<the nano-carbon coolant of 18.6%<the kerosene mist of 33.9%. The comparison of the PV values of the cut grooves in FIGS. 4A and 4B, respectively, indicates that the fluctuation ratio of the PV value of the kerosene mist is 53.0%, while the corresponding fluctuation ratio of the principal components of cutting forces of Samples A and B in FIG. 7 is 35.1%. These two fluctuation ratios do not exhibit a significant difference. This fact combined with the results of quantitative comparison of the principal components of cutting forces demonstrates that the effect of the inclusion of the nanometer-size carbon particles and the effect of the imparted electrolytic action have been obtained. The measurement data shows that the principal components of cutting forces increase with inclinations. The inclinations of the increases were started when the workpiece was attached to a jig and furthered with an increasing cutting area as the cutting of the 9-mm width of each sample proceeded in the cutting direction at a cutting speed of 150 mm/min (cutting time: approximately 2.5 seconds).

The nanometer-size carbon particles have proven to be effective for restraining the adhesion to a wearing portion of the flank of a tool. Therefore, the effect of the nanometer-size carbon particles in the coolants to restrain adhesion is considered to reduce frictional resistance also at a cutting point and in the vicinities thereof, such as a varnished area and a chip sliding area of a cutting face, thus providing the lubricating effect. The lubricating effect by the nanometer-size carbon particles is considered to have contributed to the reduced fluctuation ranges of the principal components of cutting forces of Samples B and C in FIG. 7.

FIG. 8 is a chart illustrating the results of a tool life test conducted at different cutting speeds in a cutting process using the nano-carbon electrolytic coolant. The test results indicate that higher cutting speeds (1000 mm/min, 3000 mm/min) prolong the life of a tool. The amount of wear on the tool was measured using 3D-CAD volume calculation software. A removal rate used in the test was defined as the ratio of the volume of wear on a blade edge relative to the volume of removal by cutting.

### 2.3 Forms of Chips

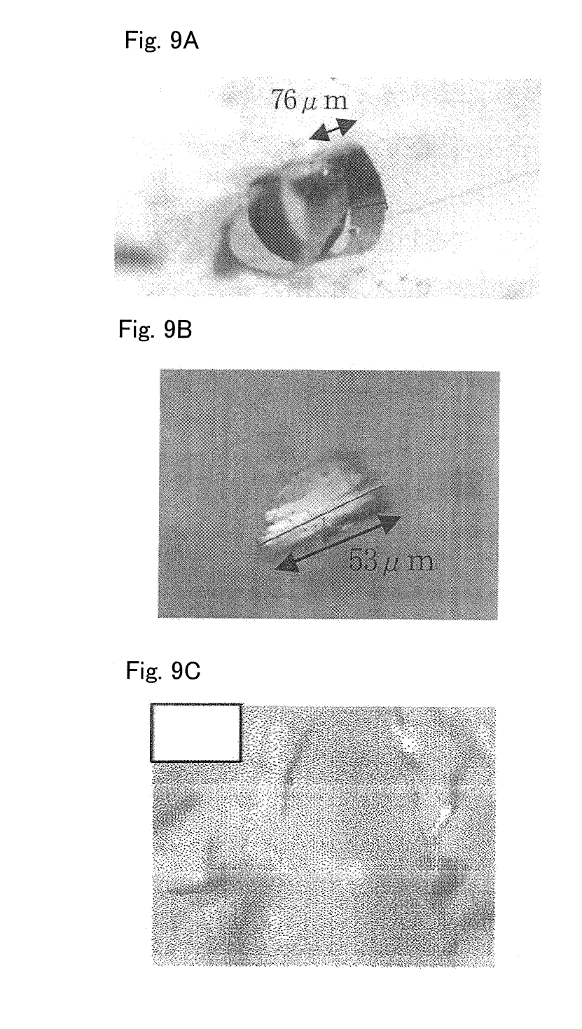

FIGS. 9A, 9B and 9C are photos showing the forms of chips. Cutting with the nano-carbon electrolytic coolant produced a curly continuous chip, as shown in FIG. 9A. Cutting with the kerosene mist produced a cracked chip, as shown in FIG. 9B. The continuous chip indicates stable cutting and an improved surface. Adjusting the ingredients of the nano-carbon electrolytic coolant has led to an improved characteristic of fragility of the chip, as illustrated in FIG. 9C. FIG. 9 shows a chip which measures 1.5 μm wide and 30 μm long.

### 3. Effects Provided by the Nano-Carbon Electrolytic Coolant

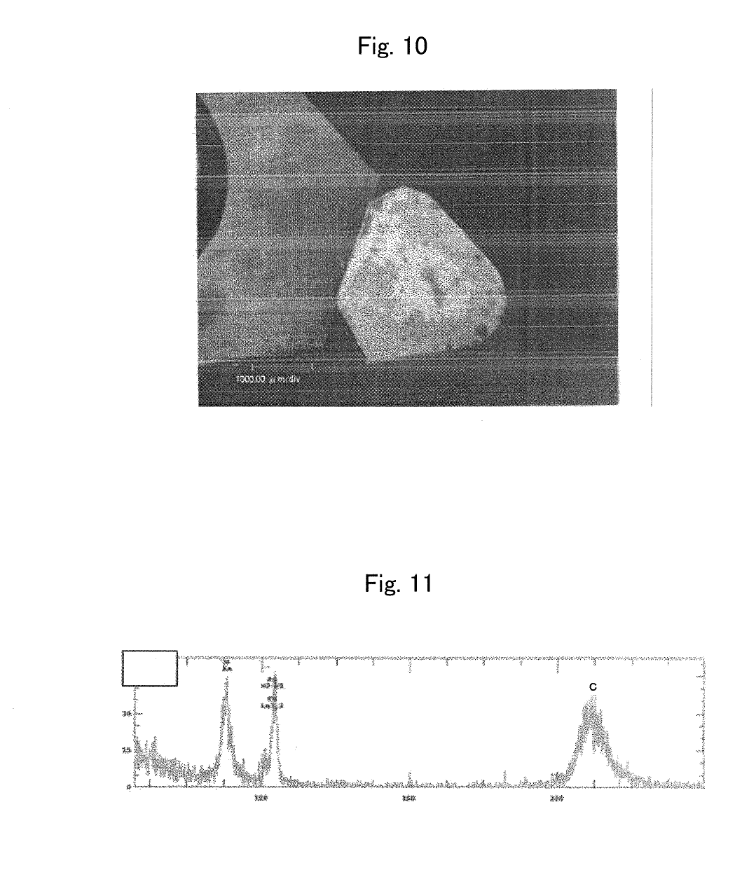

### 3.1 Effect Obtained by the Inclusion of the Nanometer-Size Carbon Particles (FIGS. 10 and 11)

Cutting a workpiece by using the nano-carbon electrolytic coolant stabilizes a cutting force. The nanometer-order-size carbon particles are considered to function as a solid lubricant like a graphite layer having an extremely low frictional coefficient. These carbon particles function as protective layers, thereby preventing typical diffusion wear. FIG. 10 illustrates a thin film formed on a diamond cutting face after 1-hour cutting with the nano-carbon electrolytic coolant. The thin film was analyzed by using an electron probe micro analyzer (EPMA). A probe was used to take a thin film substance to facilitate the sampling of the thin film substance.

FIG. 11 illustrates the analysis results obtained by the EPMA. It is seen from FIG. 11 that a carbon coating film has been formed on the surface of a diamond cutting tool. FIG. 11 shows the silver from an electrode coating material and the copper from a base plate of the EPMA. The analysis results show that a nano-carbon coating layer is formed on the surface of the diamond cutting tool, and the coating layer displays a function similar to that of a graphite layer or a typical solid lubricant. Thus, the frictional coefficient of the tool is significantly reduced, permitting stable cutting.

### 3.2 Effect of Imparted Electrolysis

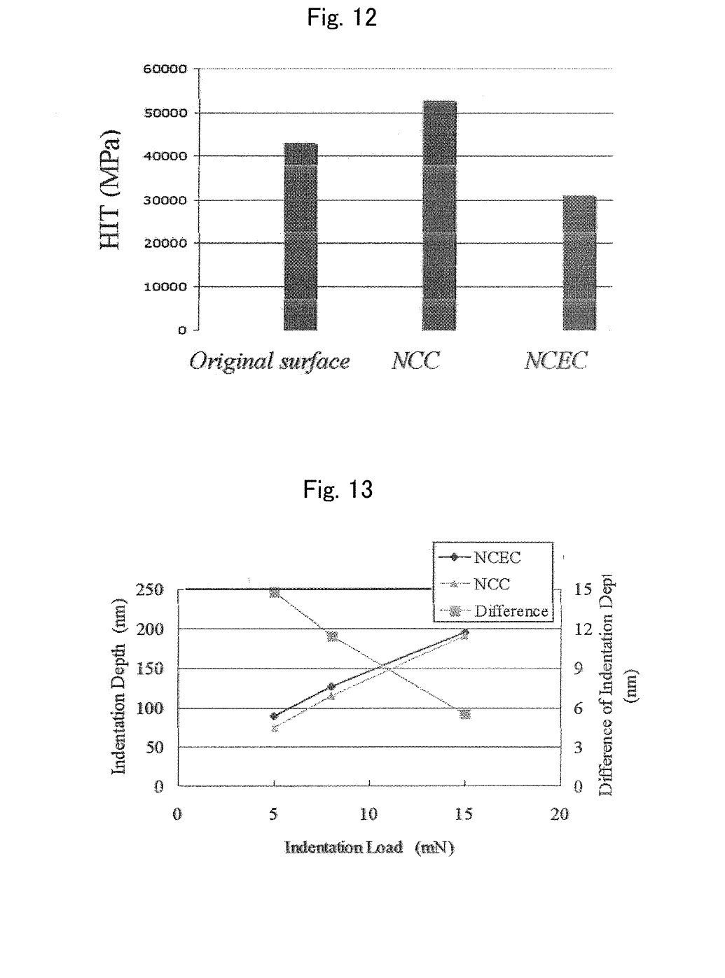

### 3.2.1 Effect of Modifying a Surface (FIGS. 12 to 17)

The nano-carbon electrolytic coolant contains chlorine ion which causes corrosion of the surface of a workpiece. Chlorine ion penetrates the crystal grain boundaries of the surface of a ferrous workpiece, forming defects in the surface, so that the crystal structure becomes fragile. During a cutting process, the nano-carbon coolant exhibited pH 9, while the nano-carbon electrolytic coolant exhibited pH 10. The pH values obviously influence the chemical reaction between the tool and the surface of the workpiece. Different types of oxidized layers are considered to be formed by complicated chemical reactions under different pH values. It is considered that if the nano-carbon electrolytic coolant of pH 10 melts the frontmost layer of the ferrous workpiece even slightly, then the frontmost layer develops an amorphous structure, which displays isotropic and homogeneous behaviors in a cutting process.

FIG. 12 is a chart illustrating the measurement results of the microhardness of the workpieces, the left bar in the chart indicating the microhardness of the original material, the middle bar indicating the microhardness obtained when the nano-carbon coolant (NCC) was used, and the right bar indicating the microhardness obtained when the nano-carbon electrolytic coolant (NCEC) was used.

As illustrated in FIG. 12, cutting with the nano-carbon coolant increased the microhardness of the surface of the workpiece, while cutting with the nano-carbon electrolytic coolant decreased the microhardness. With no electrolysis imparted, a chemical reaction on the surface during the cutting process is considered to produce a harder front layer of, for example, Fe₂O₃. It is possible that, as the coolant is electrolyzed, the pH value of the coolant changes and the chemical reaction is accelerated and the frontmost layer is molten, causing a softened frontmost layer of, for example, FeCl₃, to be formed.

Referring to FIG. 13, the thickness of the modified front layer was approximately 200 nm. Difference in microhardness of the surfaces results in different geometries of the cut grooves. The height of a burr at a groove end of the surface of the workpiece when the nano-carbon electrolytic coolant was used for cutting was one third or less of that when the nano-carbon coolant was used. This means that using the nano-carbon electrolytic coolant allows better-quality machined surfaces with fewer burrs to be obtained.

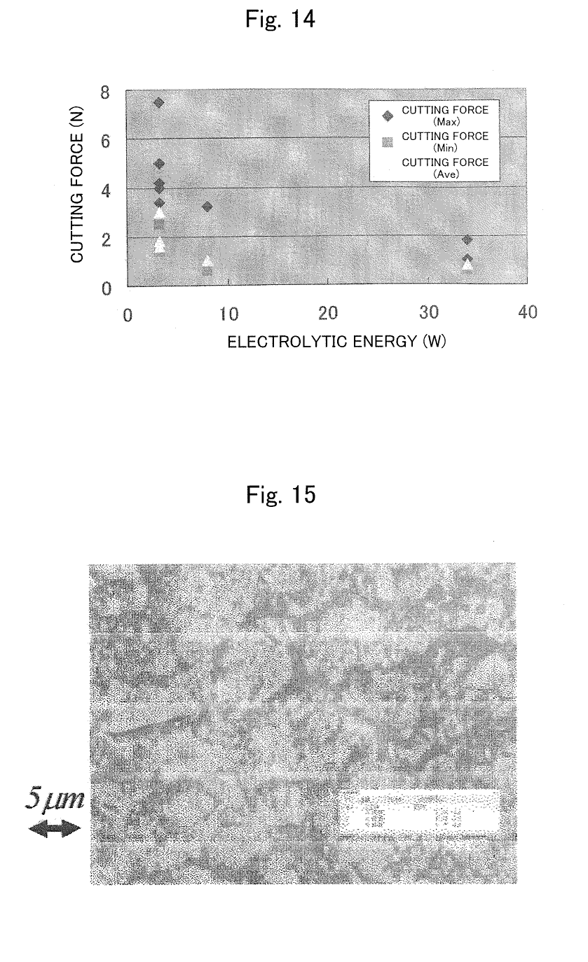

FIG. 14 is a chart illustrating a relationship between the magnitude of the electrolytic energy for imparting the electrolytic action and principal components of cutting forces. From the chart, it is seen that the mean value and fluctuation amounts of the principal components of cutting forces change according to the magnitude of the electrolytic energy. When cutting a high-carbon chromium steel material, imparting the electrolytic energy reduces the mean value and fluctuation amounts of the principal components of cutting forces. This means that improved cutting performance has been achieved.

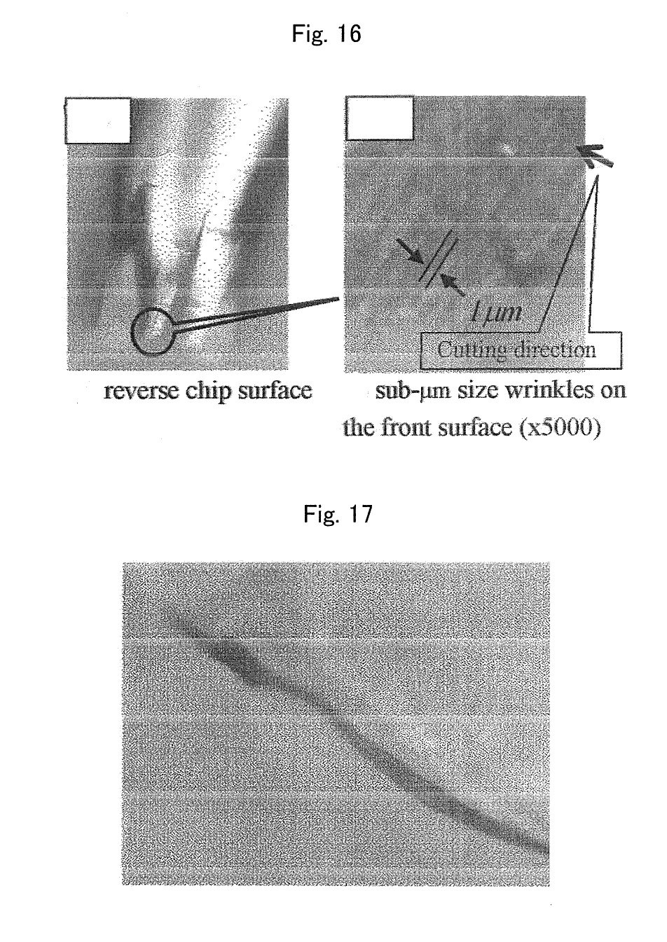

FIG. 15 is a photograph of the surface of a scarified region, which is a part of an area removed by cutting with the nano-carbon electrolytic coolant. Observing the photograph reveals the presence of pitting corrosion which has taken place inside of and in boundary of crystal grains. Further, observing a minute chip produced during the cutting with the nano-carbon electrolytic coolant reveals the presence of nanometer-size wrinkles in a direction perpendicular to the cutting direction (FIG. 16). The nanometer-size wrinkles generally have structures similar to those of layered chips produced from a substance having an amorphous structure. The distance indicated by arrows in FIG. 16 is 1 μm. Thus, it has been proven that the chemical reaction during the cutting process using the nano-carbon electrolytic coolant causes a surface of a workpiece to be fragile and reduces the influences of crystal anisotropy. This is considered to be caused by the chlorine ion in the coolant. The pitting corrosion in a surface of a workpiece caused by chlorine ion weakens the grain boundaries and crystal structure. Further, the chemical reaction presumably changed the crystal structure into an amorphous layer. This is similar to the role of slurry in a CMP process.

To understand a relationship between the nanometer-size wrinkles and the chlorine ion, an electrolytic solution free of chlorine ion was used as the nano-carbon electrolytic coolant, a chip produced was subjected to comparative observation. For this purpose, a sodium sulfate (Na₂SO₄) solution having a concentration of 0.5 mol/liter was selected and nanometer-size carbon particles and electrolytic energy were added to the solution. FIG. 17 shows the form of a chip obtained under the condition using the sodium sulfate solution. The chip shown in FIG. 17 is flat rather than curly and wrinkle-free, and measures 20 μm wide and 430 μm long. The experimental results indicate that the chlorine ion contained in the nano-carbon electrolytic coolant exerts significant influences on the form and fragility of a chip.

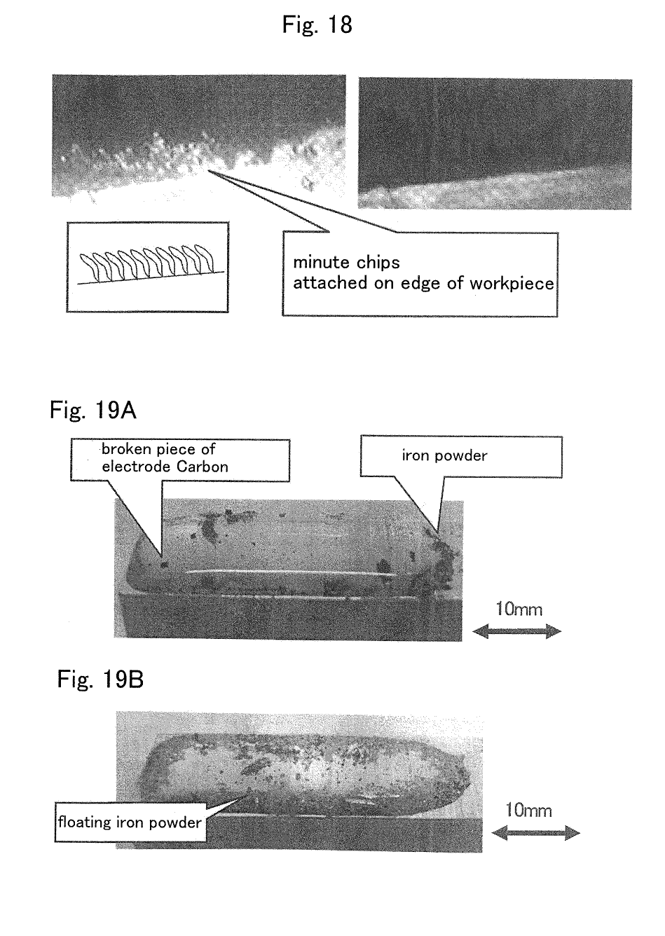

### 3.2.2 Chip Discharge Effect (FIGS. 18 and 19)

Referring to FIG. 18, when the nano-carbon electrolytic coolant is used for a cutting process, minute chips are moved to an edge of a workpiece, that is, an edge of the coolant, as shown in the photograph at left. Although the photograph does not show a detailed image, the minute chips produced during the cutting process using the nano-carbon electrolytic coolant adhere to the edge of the coolant in alignment. Meanwhile, the adhesion of minute chips produced during the cutting process using the nano-carbon coolant was not verified (the photograph at right). Presumably, therefore, the electrolytic action caused the minute chips to adhere to the edge of the coolant, preventing the chips from remaining on the surface of the workpiece. This leads to a conclusion that supplying an extremely small amount, approximately 30 ml/min, of the coolant provides the chip discharge effect.

In order to verify the chip discharge effect imparted by the electrolytic action, an experiment using iron powder was carried out. FIG. 19A illustrates a state observed immediately after iron power was sprayed onto the nano-carbon electrolytic coolant, and FIG. 19B illustrates a state observed immediately after iron powder was sprayed onto the nano-carbon coolant. The experimental results demonstrate that the iron powder sprayed onto the nano-carbon electrolytic coolant adheres to the outer periphery of the coolant. This phenomenon was not observed with the nano-carbon coolant.

### 4. Conclusion

The experiments described above have verified that the following advantages can be obtained by supplying the nano-carbon electrolytic coolant, which is prepared by electrolyzing a water-soluble cutting fluid containing nanometer-size carbon particles, to a cutting point between a high-carbon chromium steel workpiece and a single-crystal diamond tool.

(1) The inclusion of nanometer-size carbon particles permits high lubrication by reducing the frictional coefficient of a cutting blade surface, thereby making it possible to prevent adhesion between a diamond tool and a ferrous workpiece.

(2) As an effect obtained by the imparted electrolysis, active chlorine ion, active hydroxide ion, and hydrogen ion produced by an electrolytic reaction forms a corrosive modified surface on a ferrous workpiece by corrosion pitting. The modified surface weakens the structural strength of crystal grain boundaries. This is considered to lead to reduced influences of crystal grain boundaries in a cutting process. The chemical reaction changes the frontmost layer of the ferrous workpiece to be fragile, thus providing improved cutting performance and reduced heights of burrs.

(3) Imparted electrolysis allows minute chips to be efficiently discharged by an electrostatic force.

While the present invention has been described with respect to the preferred embodiments, it is to be understood that the invention is not limited to the disclosed embodiments. The scope of the invention is indicated by the appended claims, and the invention is intended to cover all modifications and equivalent arrangements included within the spirit and scope of the appended claims.

What is claimed is:

1. A method for cutting ferrous material comprising the steps of:
electrolyzing a water-soluble cutting fluid containing nanometer-size carbon particles; and
cutting a ferrous workpiece by a diamond cutting tool while supplying the electrolyzed water-soluble cutting fluid onto a cutting point between the diamond cutting tool and the ferrous workpiece.

2. The method for cutting ferrous material according to claim 1, wherein the electrolyzed water-soluble cutting fluid contains a substance which has a corrosion action on ferrous material.

3. The method for cutting ferrous material according to claim 2, wherein the substance which has a corrosion action on ferrous material is chlorine ion.

4. A cutting fluid supply device for supplying a water-soluble cutting fluid containing nanometer-size carbon particles onto a cutting point between a diamond cutting tool and a ferrous workpiece, comprising:
an electrolytic device for electrolyzing the water-soluble cutting fluid.

5. The cutting fluid supply device according to claim 4, wherein the electrolyzed water-soluble cutting fluid contains a substance which has a corrosion action on ferrous material.

6. The cutting fluid supply device according to claim 5, wherein the substance which has a corrosion action on ferrous material is chlorine ion.
